(19) United States
(12) Patent Application Publication
(10) Pub. No.: US 2009/0178403 A1
(43) Pub. Date: Jul. 16, 2009

(54) Power Station

(75) Inventor: Uwe Juretzek, Finspång (SE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, München (DE)

(21) Appl. No.: 12/086,782

(22) PCT Filed: Dec. 15, 2006
(86) PCT No.: PCT/EP2006/069748

§ 371 Date: Dec. 15, 2008

(30) Foreign Application Priority Data
Dec. 20, 2005 (EP) 05027973.6

(51) Int. Cl. F03C 5/00

(52) U.S. Cl. 60/530

(57) ABSTRACT

An aspect of the invention relates to a power plant with a condenser for condensing the process medium, characterized in that at least one separate cooling device for cooling the already condensed process medium and a component cooler are provided in series downstream of the condenser, which are configured in such a manner that the cooling device cools off the process medium to a predetermined temperature prior to entering the component cooler and that the component cooler then reheats the process medium, wherein the occurring temperature increase of the process medium is greater than the previously caused temperature reduction.

The present invention relates to a power station.

Power stations of this type are known in the prior art. They normally include a closed steam circuit, which is subdivided into a steam region and a condensate steam/feedwater region, a closed auxiliary cooling circuit and a closed intermediate cooling circuit, which has component coolers for cooling individual components in the power station. The heat emitted by the components to the intermediate cooling circuit is emitted here to the auxiliary cooling circuit unused and then via a main cooling circuit to the environment.

Furthermore, in combined-cycle gas and steam power stations (GUDs), heat is withdrawn from the hot exhaust gases of the gas turbine in a heat recovery boiler for steam generation purposes. Very large heating surfaces are needed herefor as a result of the comparatively poor heat transfer within the heat recovery boiler. The generated steam is processed in the steam turbine and is then condensed in the condenser. The condensate is transported toward the waste heat steam generator using condensate pumps, where it enters the condensate preheater. In order to avoid not achieving the dew point, a minimum condensate input temperature of 55° C. is to be observed (or else accordingly higher in the case of sulfur free fuels). This minimum temperature is guaranteed here in the case of sulfur-free and/or low sulfur fuels only by means of recirculating condensate from the condensate preheater exit to the condensate preheater entry.

In steam power stations (DKWs), the condensate/feedwater is heated upstream of the boiler entry using a steam-heated preheating path in order to increase the efficiency rate. To this end, steam is removed from the steam turbine at different pressure and temperature stages and is used to heat up heat exchangers. A rough distinction is made here between high and low pressure preheaters. The first steam-heated low pressure preheater and the draining cooler of the low pressure preheater as well as the leakage steam condenser heat the condensate up to approximately 55° C.

It is one object of the present invention to create an improved power station.

This object is achieved in accordance with the present invention by a power station as claimed in claim 1. The dependent claims relate to individual embodiments of the present invention.

The power station according to the invention includes a condenser condensing the process medium, with at least one separate cooling facility for cooling the already condensed process medium and component coolers being provided in series downstream of the condenser, which are configured in such a manner that the cooling facility cools the process medium down to a predetermined temperature prior to entering the component coolers and the component coolers then reheat the process medium again, with the temperature increase of the process medium occurring being greater than the previously caused temperature reduction.

In accordance with the invention, the condensate is thus firstly undercooled on exiting the condenser, in order to adjust the condensate temperature required to cool the components of the power station to be cooled. In this way, the component coolers can be integrated into the condensate region of the steam circuit, as a result of which neither a separate intermediate cooling circuit for cooling the power station components nor a separate auxiliary cooling circuit for absorbing the heat of the intermediate cooling circuit are needed. Accordingly a large amount of the costs arising for these cooling circuits can be saved.

While the condensate undercooled in the introduction flows through the component coolers, it absorbs the heat of the components to be cooled, with the temperature increase occurring being greater than the previously caused temperature reduction. The heat emitted by the components to be cooled, which was previously emitted to the environment by way of the auxiliary and main cooling circuit in the case of known power stations, is used in accordance with the invention to heat up the condensate, as a result of which the efficiency of the overall system is improved and the costs are likewise reduced.

The at least one cooling facility is preferably a coldwell through which cooling pipes pass, which is arranged directly below the hotwell of the condenser. In this way, the condensate is undercooled prior to its entry into the condensate pump, as a result of which the NPSH value is improved on the intake side of the condensate pump, as a result of which this can be arranged higher and the condensate pump well can be designed to be accordingly flatter.

The at least one cooling facility is advantageously powered by a cooling system having a cooling medium in order to ensure the undercooling of the condensate when exiting the condenser.

The component coolers are also advantageously connected at least partially in series in order to match the component cooling water mass flow, which is needed in order to cool the power station components to be cooled, as far as possible to the steam circuit mass flow, which is described in more detail below with reference to the drawing.

A feedback line for feeding back condensate to the condenser is also provided downstream of the component coolers, in order to be able to ensure an adequate component cooling water mass flow in the event that the steam circuit mass flow for cooling the power station components to be cooled is not adequate.

A cooling unit can be connected to the feedback line, preferably a Fin Fan cooler, in order to cool the condensate fed back through the feedback line. As a result of the cooling unit, it is possible for instance to take the cooling system cooling down the cooling facility out of operation in the event of brief downtimes of the power station, with the undercooling of the condensate than being ensured by the cooling unit alone. This likewise saves costs.

A condensate purification system is finally preferably connected to the cooling facility on the process medium side. This ensures that the condensate transported into the condensate purification system has a low temperature, as a result of which the service life as well as the regeneration cycles of the condensate purification system are increased.

The present invention is described more precisely below with reference to the appended drawing, in which;

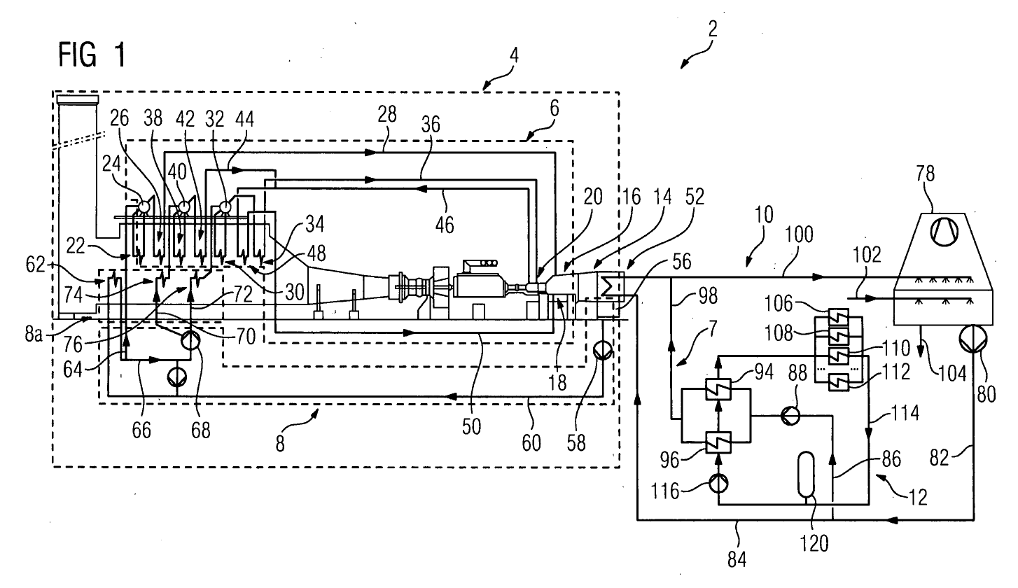

FIG. 1 shows a schematic view of a known combined-cycle gas and steam power station;

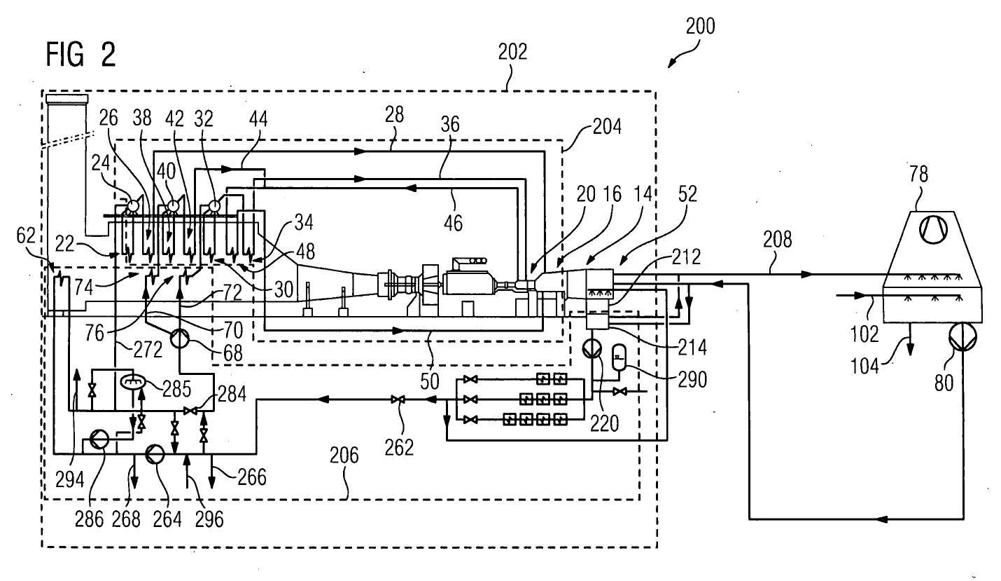

FIG. 2 shows a schematic view of an embodiment of a combined-cycle gas and steam power station according to the present invention;

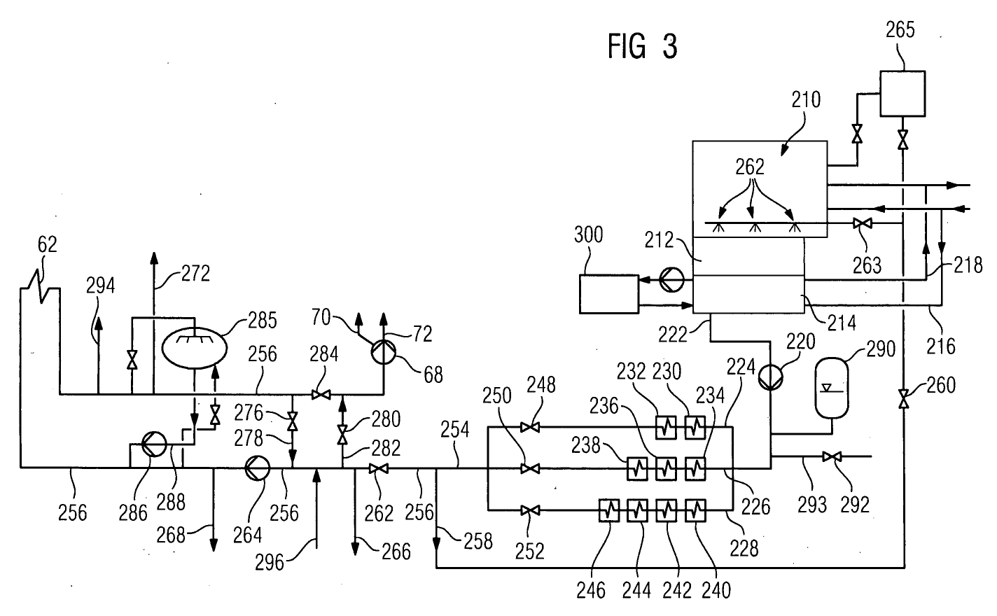

FIG. 3 shows a schematic partial view of the power station shown in FIG. 2;

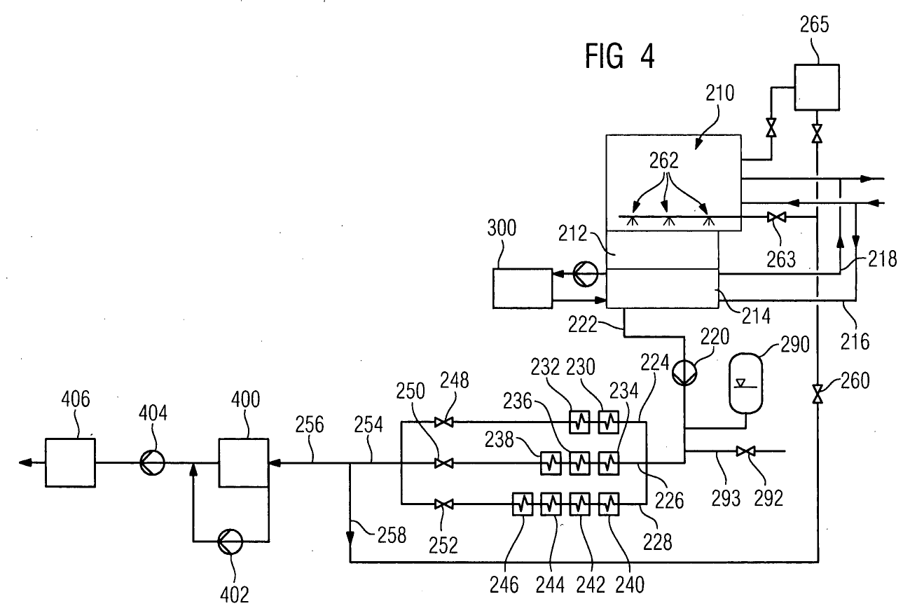

FIG. 4 shows a schematic partial view of an embodiment of a steam power station as claimed in the present invention.

The same reference characters subsequently refer to components of the same type.

FIG. 1 shows a known combined-cycle gas and steam power station 2, the steam circuit of which is designated reference character 4. The steam circuit 4 is subdivided into a steam region 6 and into a condensate/feedwater region 8. The reference character 8a designates the condensate preheating region of the condensate/feedwater region 8.

The steam power station 2 also includes a main cooling circuit 10, an auxiliary cooling circuit 11 and an intermediate cooling circuit 12 cooled down by the auxiliary cooling circuit 11, these being shown on the right in FIG. 1 and being described in more detail below.

In the steam region 6 of the steam circuit 4, the thermal energy is converted from steam in a steam turbine 14 into kinetic energy. For this purpose, the steam turbine 14 includes three pressure stages; namely a low pressure stage 16, a medium pressure stage 18 and a high pressure stage 20.

Water is partially evaporated in an evaporator 22 in order to provide the steam for the lower pressure stage 16 of the steam turbine 14. The gas and steam phases are separated in the low pressure drum 24. The steam is then overheated in an overheater 26 and is then supplied to the low pressure stage 16 of the steam turbine 14 by way of a line 28.

In order to power the high pressure stage of the steam turbine 14, water is evaporated in an evaporator 30 and the steam generated in this way is then supplied to a high pressure drum 32. The steam is then overheated in an overheater 34 and the high pressure stage 20 is supplied to the steam turbine 14 by way of a line 36.

To power the medium pressure stage 18 of the steam turbine 14, water is finally evaporated in an evaporator 38, the generated steam is supplied to a medium pressure drum 40 and then overheated in an overheater 42. The overheated steam then flows through a line 44 and mixes if applicable with steam, which is fed back via a line 46 after leaving the high pressure stage 20 of the steam turbine 15 (so-called cold intermediate overheating). The steam mixture thus generated is heated in a so-called reheater 48 and the medium pressure stage 18 is supplied to the steam turbine via a line 50. The steam leaving the steam turbine 14 is condensed in a condenser 52, which is cooled down by way of the main cooling circuit 10. The condensate thus generated is transported into a hotwell 56 arranged below the condenser 52 and is pumped from there into the line 50 via a condensate pump 58. In a condensate preheater 62, the condensate is then preheated, whereupon the line 60 branches into lines 64 and 66. The line 64 transports the condensate to the low pressure drum 24, whereupon it is evaporated again by the evaporator 22. The condensate branched into the line 66 is routed via branching lines 70 and 72 to economizers 74 and 76 by way of a feedwater pump 68 and is reheated there. The condensate leaving the economizer 74 is supplied to the medium pressure drum 40 and is then evaporated in the evaporator 38. The condensate leaving the economizer 76 is supplied to the high pressure drum 32 and is then evaporated by using the evaporator 30.

A closed steam circuit 4 is produced in this way.

The main cooling circuit 10 includes a cooling tower 78, from which cooling water is pumped into a line 82 using a cooling water pump 80. The line 82 branches into branching lines 84 and 86, with the branching line 84 transporting cooling water to the condenser 52 in order to cool the same. The partial cooling water flow flowing through the branching line 86 into the auxiliary cooling circuit 11 is pumped into the two branching lines 90 and 92 by way of a booster pump 88, where it is transported through corresponding heat exchangers 94 and 96 in order to cool the cooling water flowing through the intermediate cooling circuit. After leaving the heat exchanger 94 and 96, the cooling water is transported back into the main cooling circuit 10 through a line 98, mixes there with the cooling water produced from the condenser 52 and finally flows back to the cooling tower 78 by way of a line 100.

Accordingly, a closed main cooling circuit 10 is produced with an integrated auxiliary cooling circuit 11, with prepared cooling tower booster water being supplied to the main cooling circuit 102 by way of a line 102 and water being able to leave there by way of a line 104, which is also refereed to as cooling tower blowdown.

The intermediate cooling circuit 12 is a closed system, which is used to cool individual components of the combined-cycle gas and steam power station 2. A number of component coolers 106 to 112 which are arranged in parallel to one another are provided for cooling these components, said component coolers 106 to 112 having cooling water passing through them which absorbs the heat emitted by the components. After leaving the component coolers 106 to 112, the heated cooling water passes through a line 114 and is pumped through the heat exchangers 96 and 94 using a pump 116, whereby it is cooled. The cooled cooling water is again supplied to the component coolers 106 to 112 in order to cool the corresponding components. An expansion tank 120 for balancing out pressure fluctuations in the intermediate cooling circuit 12 caused by the temperature changes is finally effectively connected to the line 14 upstream of the pump 116.

The previously described combined-cycle gas and steam power station 10 known in the prior art has the disadvantage that the heat laboriously absorbed in the intermediate cooling circuit 12 is output to the environment unused. A further disadvantage consists in heat being withdrawn with an even greater effort from the already significantly cooled discharged air of the gas turbine (not shown) for operation of the condensate preheater 62, in order to heat the condensate flowing through the line 60.

FIG. 2 shows a schematic view of an embodiment of a combined-cycle gas and steam power station 200 according to the present invention. The combined-cycle gas and steam power station 200 includes a steam circuit 202, which is subdivided into a steam region 204 and into a condensate/feedwater region 206.

The combined-cycle gas and steam power station 200 finally includes a cooling circuit 208, which cools the condenser 210 inter alia in a manner similar to the main cooling circuit 10 shown in FIG. 1.

The combined-cycle gas and steam power station 200 differs from the combined-cycle gas and steam power station 2 known and shown in FIG. 1 essentially by the structure of the condensate/feedwater region 206 and by that of the cooling circuit 208, which is described in further detail below with reference to FIGS. 2 and 3, with FIG. 3 showing an enlarged and more detailed view of the condensate/feedwater region 206 shown in FIG. 2.

The basic structure of the condensate/feedwater region 206 is shown first below.

The condenser 210 includes a hotwell 212 and a coldwell 214 arranged therebelow. The coldwell 214 is through which cooling tubes pass, which are supplied with cooling water from the cooling circuit 209 by way of line 214, said cooling water then being transported back into the cooling circuit 208 by way of line 218. The cooling water flowing through the cooling tube withdraws the heat from the condensate flowing through the coldwell 214, so that this leaves the coldwell 214 undercooled via the line 222 using the condensate pump 220. The undercooled condensate is then supplied to several component coolers 230 to 246 by way of branching lines 224, 226 and 228, said component coolers serving to cool individual components in the power station 200, connected partly in series and partly in parallel.

The condensate flowing through the lines 224, 226 and 228 is heated little by little by the heat exchange occurring in the component coolers 230 and 246, with the temperature increase occurring in the component coolers 230 and 246 being greater than the temperature reduction of the condensate occurring in the coldwell 214, i.e. more heat is supplied to the condensate in the component coolers 230 to 246 than was previously withdrawn therefrom in the coldwell 214. A trimming valve 246, 250 and 252 is provided in each instance at the end of the line 224, 226 and 228, in order to adjust the quantity of condensate flowing through the lines 224, 226 and 228. The condensate leaving the lines 224 to 228 is combined in line 254, which in turn branches into the line 256 and into the feedback line 258.

A condensate mass flow is guided through the feedback line, said condensate mass flow supplementing the steam mass flow flowing out of the steam region into the condenser 210 to such a degree that a suitable cooling of the components of the power station 200 to be cooled by means of the component coolers 230 to 246 is ensured. The feedback line 258, in which an emergency trip valve 260 is provided, leads back to the condenser 210, where the fed-back condensate is sprayed into the condenser 210 via nozzles 262 and is flashed out. Here valve 263 controls the condensate mass flow fed back through the feedback line 258. A separate Fin Fan cooler 265 can optionally also be provided, which is used to cool the condensate flowing back into the condenser 210 through the feedback line 258. As a result of the Fin Fan cooler 265, it is possible for instance to take the cooling circuit 208 out of operation in the event of brief downtimes of the power station 200, with the cooling then taking place solely by way of the Fin Fan cooler 265. Costs can likewise be saved in this way. As a result of the available large surfaces of the condenser 210, of the hotwell 212 and of the coldwell 214, by way of which heat is emitted to the environment, it is even possible, if applicable, to dispense with the Fin Fan cooler 265 in the event of a brief system downtime.

The condensate flowing through the line 256 first flows through an emergency trip valve 262. A line 266 branches from the line 256 downstream of the emergency trip valve 262, through which line 266 the condensate is transported during bypass operation, to the low pressure bypass station. The line 256 includes a condensate pump 264 downstream of the emergency trip valve, said condensate pump 264 pumping the condensate onwards to the condensate preheater 62. A line 268 also branches off between the condensate pump 264 and the condensate preheater, through which line 268 condensate is transported to the medium pressure bypass station during bypass operation. In the condensate preheater 62, the condensate is heated and is then pumped from the condensate preheater 62 via the line 272 to the low pressure drum 24 as well as to the entry of the feedwater pump 68.

If the preheating of the condensate through the component coolers 230 to 246 is not sufficient to avoid not achieving the dew point, the condensate pump 264 enables the recirculation of the condensate occurring from the condensate preheater 62 in order to ensure the required condensate preheater input temperature, by the required condensate mass flow being supplied via a valve 276 by way of a line 278 prior to entering the condensate pump 264.

If necessary, a valve 280, which is arranged in a line 282, releases the cold bypass, like for instance in the case of oil operation and a bypass dearator which fails at the same time (or the bypass operation described below).

The valve 284, which is provided in the line 256 upstream of the feedwater pump 68, is used to back up the pressure of the condensate pump 264, which thus achieves the pressure level required for providing the injection water for the medium pressure bypass station. In this instance, the cold bypass is partially open. In addition, the valve 284 enables the necessary trimming in the case of a cold bypass to be opened.

The recirculation of the condensate with the condensate pump 264 is adjusted during the bypass operation (i.e. the generated steam is transported directly into the condenser 210). The heating of the significantly reduced condensate flow in the direction of the condensate preheater 62 takes place by means of a bypass dearator 285. This ensures that the dew point at the cold end of the boiler is reached. The size of the condensate pump 264 thus does not need to be measured for the bypass operation. The pump size can be configured to be stronger during normal operation (including recirculation), as a result of which the internal energy requirements and the pump size can be reduced.

The bypass dearator 285 is simultaneously powered by way of the condensate mass flow transported by the condensate pump as a medium to be de-gassed as well as to partially heat up the condensate mass flow. The degassed condensate is fed by way of a corresponding pump 286 downstream of the condensate pump 264 via a line 288, namely downstream of the line 268 leading to the medium pressure bypass station.

A compensating reservoir 290 with a nitrogen blanket is arranged on the pressure side of the condensate pump 220. This compensating reservoir is used to retain the pressure in the system during a planned or unplanned downtime of the pump 220. To ensure that this pressure is retained, the corresponding emergency trip valves 260 and 262 are to be closed. Furthermore, a replenishment line 293 from the demineralized water distribution system provided with a valve 293 ensures that pressure is maintained.

A condensate purification system 300 can optionally be connected to the coldwell 314. As a result of the undercooled condensate, the service life as well as the regeneration cycles of the condensate purification system 300 can be increased accordingly, thereby resulting in a cost saving.

The structure of the combined-cycle gas and steam power stations 2 and 200 shown in FIGS. 1 to 3 are subsequently compared with one another and the advantages of the present invention are highlighted:

By comparison with the power station 10 shown in FIG. 1, in the power station 200 shown in FIGS. 2 and 3, the condenser is enlarged and is separated into two regions, namely into the hotwell 212 and into the coldwell 214. The hotwell 212 essentially has the same size as the hotwell 56 and is used to balance out level fluctuations. The condensate is then transported out of the hotwell 212 through a sufficiently largely dimensioned opening into the coldwell 213 disposed therebelow, which is always full, and is undercooled by means of the cooling tubes drawn through the coldwell 214. This arrangement ensures on the one hand that the condensate temperature on the surface of the hotwell 212 is not reduced and thus the solution of gases is not increased. It is also possible to dispense with the heat exchangers 94 and 96 of the intermediate cooling circuit 12 shown in FIG. 1, as a result of which a reduction in the surface requirement in the building is achieved. The cooling tubes passing through the coldwell 214 have the same internal diameter as the other condenser tubing, but are however significantly shorter, thereby resulting in a reduced loss in pressure, as a result of which it is also possible to dispense with the booster pump 88 illustrated in FIG. 1. The undercooling of the condensate occurring in the coldwell 214 also causes the NPSH value on the suction side of the condensate pump 230 to be improved, so that this can be arranged higher, as a result of which the condensate pump well can be designed to be flatter.

A cooling water partial mass flow defined in accordance with a worst case scenario ensures that the condensate leaving the coldwell 214 is a maximum of 5K warmer than the entering cooling water (it thus corresponds to the boundary conditions previously applying to the intermediate cooling system 12 and the main cooling water system 10). This worst case cooling water partial mass flow approximately amounts to half of the mass flow, since with full load the total intermediate cooling system heat is dissipated in the direction of the boiler during normal operation (or a large part thereof, in the case of high ambient temperatures). Only the arriving, comparatively low-energy condensate mass flow from the steam region is now to be cooled. This reduced auxiliary cooling water circuit-cooling water mass flow is also sufficient in the case of a low partial load and during the bypass operation since the heat input by the generator and/or the load of the generator are reduced accordingly. This reduction in the mass flow results in a marginal reduction in size of the cooling water pump 80 of the cooling water circuit shown in FIG. 1, as a result of which the internal energy requirement is also reduced.

In addition to transporting the condensate from the coldwell 214 in the direction of the boiler, the condensate pump 220 also assumes the function of the pump 116 of the intermediate cooling circuit 12 illustrated in FIG. 1. The conveying pressure must be determined here such that the pressure in the condensate region is higher than in the lubricating oil system and in the sealing system under all operating conditions in order to be able to reliably exclude contamination by oil of the steam circuit as a result of leakages. A compensating reservoir with nitrogen blankets is arranged on the pressure side of the condensate pump 220. This compensating reservoir is used to retain pressure in the system during a planned or unplanned downtime of the pump 220. To ensure that pressure is retained, the corresponding emergency trip valves 260 and 262 are to be closed. Furthermore, a replenishment from the demineralized water distribution system also ensures that pressure is retained.

As already mentioned above, the valve 263 controls the condensate mass flow required to cool the individual components of the power station 200, said condensate mass flow being needed in addition to the mass flow transported out of the steam region into the condenser 210. This recirculation mass flow is controlled as a function of the temperatures measured with the components to be cooled and the determined temperature target values and temperature limit values. Here the recirculation mass flow is increased and/or reduced until all temperature target values and/or temperature limit values are met.

The recirculation and the subsequent injection of finely atomized, heated condensate into the condenser 210 which is flashed out here results in improved degassing in the condenser. If a condensate purification system exists, it is thus possible, if necessary, to dispense with the bypass dearator. This omission is even possible in the case of sulfurous fuel gas without noticeably affecting the performance, since the required input temperature of 75° C. can only be achieved by means of recirculation (the cold bypass can remain closed; the recirculation mass flow must however be brought to the previous (“oil operation level”).

In order to maximize the benefits of the preheating, as well as the largest possible temperature increase in the condensate (which is achieved by a series circuit of component coolers, which is explained in more detail below), it is also an objective, as far as possible, to retain the total heat absorbed in the water vapor circuit and thus to minimize the recirculation in the direction of the condenser 210. This is achieved if the component cooling water mass flow and the steam circuit mass flow are largely approximated. To this end, the following actions are to be taken:
as many component coolers as possible are to be connected to one another in series rather than in parallel, with the rules still to be described in further detail below to be taken into account for the series and/or parallel circuit;
the temperature target values and temperature limit values are also to be smoothly adjusted to the respective operating state in the case of the generator. By way of example, the cold gas temperature to be achieved can be adjusted as a function of the active power and of the reactive power required in each instance;
in addition, three-way valves are to be provided in the case of redundant component coolers, in other words in the case of two component coolers for one component, with one of the component coolers already ensuring adequate cooling of the component and the other only being used as backup, in order not to have to flow through component coolers which are operating in each instance.
the component coolers of 100% redundant components (i.e. normally always only one of the components is ever operating) are to be connected in series in each instance, with a bypass guided around the component cooler ensuring that maintenance is possible during operation.

When defining component coolers, which are connected in series, the following factors are to be considered:

The fundamental idea in the case of the basic sequence in the series circuit of component coolers consists in the components to be cooled allowing different cooling water temperatures depending on their function, so that the temperature limit values are accordingly different. In this case, the component with the lowest temperature limit value is accordingly arranged first in the series and the component with the highest temperature limit value is arranged last in the series.

First of all, coolers of components are arranged in series, in which the function and dimensioning of the components to be cooled depend heavily on a low temperature and/or in which a low temperature is needed in order to guarantee the measurement accuracy, with the absolute heat input being comparatively low however, as a result of which the cooling of consecutive components is only influenced slightly (this generally relates to the evacuation pumps (MAJ) and the sampling system (QU)).

Component coolers of components are then arranged, in which the type and dimensioning of the components to be cooled heavily depend on a low temperature, like for instance the generator.

Component coolers of components are then arranged, in which the type or dimensioning of the components to be cooled are not or only marginally negatively affected by higher coolant temperatures (this relates in particular to the lubricating oil cooler and pump bearings cooling).

The component cooler for the leakage steam condenser is generally arranged last in series, with a significant throughflow having to be ensured.

The following factors should be considered when determining lines which are connected in parallel.

A parallel circuit must then always be used if temperature limit values for individual components cannot be adhered to by means of a series circuit and corresponding change in design of the components to be cooled is technically not possible or economically not favorable.

Associated components are to be arranged in the same line, like for instance the generator cooler and the associated lubricating cooler of the turboset.

Components with similar requirements in respect of the cooling water flow can be combined in a separate line in order to avoid an unnecessary overdimensioning of the component cooler. It is alternatively also expedient to select a parallel circuit of several component coolers of a component type instead of a separate line. This may be the case with redundant components having a redundancy <100% (e.g. three times 50% configuration), or if the size of a component cooler of a component were to increase considerably as a result of subsequent components and the large cooling mass flows required therefor (e.g. elmopump cooler with 2×1 multiwave configuration of the combined cycle gas and steam power station).

In order to flow through the parallel lines to a desired extent, trimming valves, which can be motorized if necessary, are provided on the end of each line, as was described previously. The injection water station of the low pressure bypass station is powered by means of the condensate pump 220. The losses and thus by comparison the internal energy requirements thus reduce as a result of the low pressure level.

An approximate calculation of the condensate mass flow required for component cooling purposes results in the mass flow required in the bypass operation being needed as a maximum. From this perspective, the requirements of the pump 220 is thus not greater than those of the pump 116 of the intermediate cooling circuit shown in FIG. 1, since the pressure which is higher approximately by the factor 2 to 3 is compensated for by the reduction in the mass flow to approximately a half or a third thereof. The energy required to operate the pump 220 remains favorable within the circuit and is not completely lost as in the case of a separate intermediate cooling circuit. The energy required is reduced accordingly. Furthermore, it is possible to change from medium voltage to low voltage (in systems larger by approximately 400 MW) in comparison with the condenser preheating region shown in FIG. 1, as a result of the interconnection of the condensate preheater region shown in particular in FIG. 3 by virtue of the reduced power consumption. The pressure increase which is naturally also required is ensured by the condensate pump 264, which however only requires a low voltage drive by virtue of its size.

As was already described previously, the condensate pump 264 transports the condensate to the medium pressure bypass station (only during the bypass operation), into the bypass dearator as well as into the condensate preheater of the boiler and from there back into the low pressure drum and into the feedwater pump.

As the condensate was already preheated by way of the component cooler, the condensate preheater heating surface in the boiler can be reduced by approximately 20% (which corresponds approximately to 6% of the overall boiler heating surface. This thus results in a corresponding reduction in the size of the boiler and thus in the space required and in a reduction in the necessary foundations. In extreme cases, as a function of environmental/operating conditions, it is possible to completely dispense with cooling the Coldwell 214, at least temporarily. Accordingly, the condensate preheating heater surface can be reduced by up to approximately 30%.

The reduction in the heating surface also results in a slight reduction in the pressure loss of the gas turbine on the discharged air side as well as an increase in the performance of the gas turbine, aside from the reduction in the boiler costs. A reduction in the pressure losses on the water side and thus in the internal energy requirement is also effected by means of a reduction in the heating surface.

If the preheating of the condensate is not sufficient to avoid not achieving the dew point, the condensate pump 264, as was previously already mentioned, allows the recirculation of the condensate in order to ensure the required minimum condensate preheating input temperature, by supplying the desired mass flow through the valve 276 upstream of the pump entry of the condensate pump 264. It is thus possible to dispense with a separate recirculation pump and/or taps on the feedwater pump 68.

In any case, the preheating of the condensate results in both the required recirculation mass flow and thus in the internal energy requirement being reduced.

The valve 280 releases the cold bypass, if necessary (e.g. with oil operation and a bypass generator 285 which fails at the same time and/or the bypass operation described as follows).

The valve 284 is used to back up the pressure in the condensate pump 264, which thus achieves the pressure level required for providing the injection water for the medium pressure bypass station. In this case, the cold bypass is partially open. Furthermore, the valve enables the required trimming in the case of a cold bypass to be opened.

The recirculation of the condensate by means of the condensate pump 264 is adjusted during the bypass operation (i.e. the generated steam is routed directly into the condenser 210). The significantly reduced condensate flow in the direction of the condensate preheater 270 is preheated by means of the bypass dearator 284 (this ensures that the dew point at the cold end of the boiler is reached). The size of the condensate pump 264 thus does not need to be measured for the bypass operation. The pump size can be oriented more strongly to normal operation (including recirculation), so that the internal requirements and pump size can be reduced.

At the same time, the bypass dearator 285 is powered by way of the mass flow transported by the condensate pump 264 (as a medium to be degassed as well as for partially heating up the mass flow). The degassed condensate is supplied via the pump 286 downstream of the condensate pump 264, namely behind the branch for injection into the medium pressure bypass station.

If necessary, a fuel gas preheating can be powered via a line 294 using the mass flow transported by the condensate pump 264. The return flow is supplied via a line 296 upstream of the pump entry of the condensate pump 264.

FIG. 4 shows a schematic partial view of an embodiment of an inventive steam power station. The partial view shown in FIG. 4 differs in this respect from the partial view shown in FIG. 3 in that the condensate pump 264 is not connected to the valve 262 but instead a low pressure preheater 400 is provided, which is powered with tapping steam from the steam turbine (not shown). The drainage of this low pressure preheater 400 is fed back into the main condensate line by means of a pump 402 and not as usual into the condenser. A further condensate pump 404 is connected to the low pressure preheater 400, said condensate pump 400 transporting the condensate through further preheaters in the direction of the boiler. In the case of an extensive series circuit of component coolers 230 to 246, the low pressure preheater 400 can be omitted and the heat input over the additional preheater 406 can be reduced. In this case, the benefits not only result from the cost savings in terms of electrical internal requirements but also above all in terms of an increase in the gross output and gross efficiency and would thus be valued more highly than in the case of a combined-cycle power station.

1.-8. (canceled)

9. A power station, comprising:
a condenser that condenses a process medium;
a separate cooling facility that further cools the condensed process medium; and
component coolers arranged one after the other downstream of the condenser, configured such that the cooling facility cools off the process medium to a predetermined temperature prior to entering the component coolers and the component coolers then reheat the process medium, where the temperature increase of the process medium is greater than the previously caused temperature reduction.

10. The power station as claimed in claim 9, wherein the cooling facility is a coldwell through which cooling tubes pass.

11. The power station as claimed in claim 10, wherein the cooling facility is powered by a cooling system having a cooling medium.

12. The power station as claimed in claim 11, wherein the component coolers at least partially are connected in series.

13. The power station as claimed in claim 12, wherein a feedback line for feeding back condensate to the condenser is provided downstream of the component coolers.

14. The power station as claimed in claim 13, wherein a cooling unit is connected to the feedback line.

15. The power station as claimed in claim 14, wherein the cooling unit is a Fin Fan cooler.

16. The power station as claimed in claim 15, wherein a condensate purification system is connected to the cooling facility on the process medium side.
